(19) United States
(12) Patent Application Publication
(10) Pub. No.: US 2021/0317043 A1
(43) Pub. Date: Oct. 14, 2021

(54) MAGNESIA, METHOD FOR MANUFACTURING SAME, HIGHLY THERMALLY CONDUCTIVE MAGNESIA COMPOSITION, AND MAGNESIA CERAMIC USING SAME

(71) Applicant: Korea Institute Of Materials Science, Changwon-si, Gyeongsangnam-do (KR)

(72) Inventors: Cheol-Woo AHN, Changwon-si (KR); Jong-Jin CHOI, Busan (KR); Byung-Dong HAHN, Changwon-si (KR)

(73) Assignee: Korea Institute Of Materials Science, Changwon-si, Gyeongsangnam-do (KR)

(21) Appl. No.: 17/285,349

(22) PCT Filed: Dec. 13, 2019
(86) PCT No.: PCT/KR2019/017746

§ 371 Date: Apr. 14, 2021

(30) Foreign Application Priority Data
Dec. 13, 2018 (KR) 10-2018-0161252

(51) Int. Cl. C04B 35/04; C09C 1/00; C04B 35/628; C04B 35/645; C09K 5/14

(52) U.S. Cl. CPC C04B 35/04; C04B 2235/9607; C04B 35/62821; C04B 35/62823; C04B 35/62826; C04B 35/62815; C04B 35/62813; C04B 35/62807; C04B 35/645; C09K 5/14; C04B 2235/3206; C04B 2235/3232; C04B 2235/3251; C04B 2235/3244; C04B 2235/3217; C04B 2235/3239; C04B 2235/3409; C04B 2235/3225; C04B 2235/3418; C04B 2235/3272; C09C 1/0009

(57) ABSTRACT

The present invention discloses magnesia and a method for manufacturing same, wherein the magnesia can be produced into granules of various shapes and sizes and can be improved in moisture resistance with the formation of a moisture resistant surface oxide layer by donor addition and then thermal treatment. The magnesia according to the present invention comprises a MgO granule; and a surface oxide layer formed on a surface of the MgO granule and a composition of the surface oxide layer is different from a composition of an inside of the MgO granule.

### CROSS-REFERENCE TO RELATED APPLICATIONS

This application is a national phase under 35 U.S.C. § 371 of PCT International Application No. PCT/KR2019/017746 which has an International filing date of Dec. 13, 2019, which claims priority to Korean Application No. 10-2018-0161252 filed on Dec. 13, 2018, the entire contents of each of which are hereby incorporated by reference.

### TECHNICAL FIELD

The present disclosure relates to magnesia for ceramic filler that is improved in moisture resistance with formation of a surface oxide layer including a MgO-donor on a surface of a MgO granule by addition of a donor to a MgO powder and then thermal treatment, and accordingly, is used for thermal interface material, and the surface oxide layer being different from an inside of the granule in terms of composition, and a method for producing the magnesia for ceramic filler. In addition, the present disclosure relates to a highly thermally conductive magnesia composition capable of reducing a sintering temperature and improving a thermal diffusion coefficient with the addition of the donor to the MgO, and magnesia ceramics using the same.

### BACKGROUND ART

Heat dissipation packages have been used to ensure reliability of components and a long lifespan in manufacturing components such as high-power LEDs or power devices having high power consumption and a large amount of heat generation.

In general, the heat dissipation package includes a highly thermally conductive insulating substrate and a metal heat sink. A thermal interface material (TIM), which is a heat dissipating adhesive, is used between the highly thermally conductive insulating substrate and the metal heat sink.

The TIM functions as the adhesive to adhere the highly thermally conductive insulating substrate to the metal heat sink or is used alone as a heat dissipation component. The TIM is made of a composite of a polymer and highly thermally conductive metal or a composite of a polymer and ceramic filler material.

The TIM includes an Al₂O₃ filler in a polymer.

However, the Al₂O₃ filler material has slightly low thermal conductivity of 20 to 30 W/mK and needs an improvement in the thermal conductivity thereof.

Meanwhile, MgO has a raw material price that is equal to that of Al₂O₃ and has thermal conductivity of 30 to 60 W/mK, which is superior to that of the Al₂O₃ filler material. In addition, the MgO has specific resistance of 10¹⁴ Ohm cm or more, so the MgO has excellent electrical insulation. Accordingly, if the MgO filler is used instead of the Al₂O₃ filler, the thermal conductivity of the Al₂O₃-based TIM may be improved. Therefore, the MgO filler is useful for a filler for the TIM.

However, as the MgO has relatively high moisture absorption, the thermal conductivity thereof is decreased due to the moisture absorption. In addition, Mg(OH)₂ generated on the surface of the MgO based on the moisture absorption makes it difficult to form a complex with a polymer. In this case, it is difficult to produce the TIM. In addition, there is a problem in that a high possibility in which Mg(OH)₂ may be separated from the polymer material due to volume expansion of the TIM exists. The configuration is an obstacle to practical use of MgO as a thermally conductive ceramic filler. Therefore, development of a technology capable of improving the moisture resistance may be preceded to develop the MgO as the thermally conductive ceramic filler for TIM.

Meanwhile, the MgO has an advantage of highly thermally conductivity of 30 to 60 W/mK compared to alumina (Al₂O₃).

However, there is a disadvantage in that magnesia (MgO) is sintered at a high temperature of 1700° C. of higher while alumina (Al₂O₃) is sintered at about 1500 to 1600° C. Accordingly, the sintering conditions of the magnesia (MgO) need to be improved. A low-temperature sintering of the magnesia (MgO) has been attempted; however, heat dissipating ceramics capable of maintaining the thermal conductivity and reducing the sintering temperature have not been studied.

Therefore, there is a need for development research of a new, low-cost, highly thermally conductive oxide material with price competitiveness by enabling sintering at a temperature lower than 1500° C., which is the sintering temperature of the alumina (Al₂O₃), while maintaining the highly thermally conductive property of the magnesia (MgO).

### RELATED ART DOCUMENT

### Patent Document

(Patent Document 001) KR Patent Publication No. 10-2016-0014590 (published on Feb. 11, 2016)

### DISCLOSURE

### Technical Problem

The present disclosure provides magnesia that has excellent moisture resistance, and accordingly, may be used for a ceramic filler for thermal interface material, and a method for producing the magnesia.

The present disclosure further provides a magnesia (MgO) composition and magnesia (MgO) ceramics capable of performing low-temperature sintering (<1500° C.) and having highly thermally conductive properties.

The objects of the present disclosure are not limited to those mentioned herein, and other objects and advantages of the present disclosure which are not mentioned may be understood by the following description and more clearly understood by the embodiments of the present disclosure. It will also be readily apparent that the objects and the advantages of the present disclosure may be implemented by features described in claims and a combination thereof.

### Technical Solution

The present disclosure provides a method for producing magnesia (MgO). The method includes the steps of: (a) using a donor and an organic solvent for a MgO powder to prepare a mixture; (b) drying the mixture; (c) forming donor-added MgO granules from the mixture; and (d) thermally treating the donor-added MgO granules, and the donor-added MgO granules have a surface oxide layer formed on the surface thereof upon the thermal treatment, the surface oxide layer being different from an inside of the MgO granules in terms of composition.

In addition, the present disclosure provides the method for producing magnesia (MgO). The method includes (a) adding a donor and distilled water to a Mg(OH)₂ powder to prepare a mixture; (b) drying the mixture; (c) forming a donor-added Mg(OH)₂ granule from the mixture; and (d) thermally treating the donor-added Mg(OH)₂ granule, and the donor-added Mg(OH)₂ granules have a surface oxide layer formed on the surface of the MgO granule upon the thermal treatment of the donor-added Mg(OH)₂ granule, the surface oxide layer being different from an inside of the MgO granules in terms of composition.

In addition, the present disclosure provides magnesia (MgO). The magnesia (MgO) includes the MgO granule; and a surface oxide layer formed on the surface of the MgO granule, and a composition of the surface oxide layer is different from that of the inside of the MgO granule.

In addition, the present disclosure provides a magnesia (MgO) composition including TiO₂, Nb₂O₅, ZrO₂, or Al₂O₃ in a MgO matrix and satisfying the following Equation (1), Equation (2), Equation (3), or Equation (4).

MgO+x wt. % of TiO₂ Equation (1)

MgO+y wt. % of Nb₂O₅ Equation (2)

MgO+z wt. % of ZrO₂ Equation (3)

MgO+w wt. % of Al₂O₃ Equation (4)

(In Equations (1) to (4), x, y, z, and w are 0<x, y, z, w<10.0.)

### Advantageous Effects

According to the present disclosure, a method for producing magnesia enables forming, on a surface of a MgO granule and by thermal treatment, a surface oxide layer which has a composition that is different from that of an inside of the granule and including “MgO and donor material”, thereby having an effect of improving low moisture resistance of the MgO. The magnesia may be used for a ceramic filler for thermal interface material.

In addition, according to the present disclosure, the magnesia (MgO) having the high thermal conductivity may be sintered at a temperature lower than 1500° C. and thermal diffusion coefficient thereof may be improved by adding, to magnesia (MgO), a ceramic composition including at least one of TiO₂, Nb₂O₅, ZrO₂, Ga₂O₃, Mn₂O₃, B₂O₃, Fe₂O₃, SnO₂, MnO₂, SiO₂

, V₂O₅, Ta₂O₅, Sb₂O₅, Y₂O₃, Eu₂O₃, Er₂O₃, or Al₂O₃. The magnesia (MgO) material may be used as a low-cost, heat dissipating ceramic material.

Hereinafter, further effects of the present disclosure, in addition to the above-mentioned effect, are described together while describing specific matters for implementing the present disclosure.

### DESCRIPTION OF DRAWINGS

FIG. 1 is a conceptual diagram showing formation of a dense surface oxide layer by thermal treatment, and a picture of microstructures of a surface oxide layer and an inside of a sintered body during production of the MgO granule of the present disclosure.

FIG. 2 is a microstructure picture showing shapes and sizes of MgO granules produced according to a producing method of the present disclosure and a microstructure picture of a surface thereof before and after thermal treatment (at 1400° C. for 2 h).

FIG. 3 is a picture showing a difference between water resistance of a MgO raw material powder and water resistance of a MgO granule thermally treated (at 1400° C. for 2 h) after adding a donor to a MgO powder.

FIG. 4 is a microstructure picture of fracture surfaces of a sample of MgO+0.3 wt. % of TiO₂+0.3 wt. % of Nb₂O₅+0.2 wt. % of SiO₂ (at a left side) and a sample of MgO+0.3 wt. % of TiO₂+0.3 wt. % of Nb₂O₅ (at a right side), which are thermally treated at 1400° C. for 2 h, to identify thicknesses of surface oxide layers thereof.

FIG. 5 shows an energy dispersive X-ray spectroscopy (EDS) analysis results and microstructure pictures used to identify formation of a surface oxide layer including a MgO-donor in a sample of MgO+0.3 wt. % of TiO₂+0.3 wt. % of Nb₂O₅+0.2 wt. % of SiO₂ which is thermally treated at 1400° C. for 2 h.

FIG. 6 is a graph showing changes in thermal diffusivity of a sample sintered after adding a TiO₂ composition to magnesia (MgO).

FIG. 7 is a graph showing a change in thermal diffusivity of a sample sintered after adding an Nb₂O₅ composition to magnesia (MgO).

FIG. 8 is a graph showing a change in thermal diffusivity and a change in density of a sample sintered after adding a trace amount of TiO₂ (or Nb₂O₅) composition to magnesia (MgO).

FIG. 9 is a graph showing changes in thermal diffusivity and density of a sample sintered after adding 0.3 wt. % of TiO₂+a trace amount of Nb₂O₅ composition to magnesia (MgO).

FIG. 10 is a graph showing changes in thermal diffusivity of a sample sintered after adding a ZrO₂ composition to magnesia (MgO).

FIG. 11 is a graph showing changes in thermal diffusivity of samples sintered after adding 0.3 wt. % of TiO₂+0.3 wt. % of Nb₂O₅+a ZrO₂ composition to magnesia (MgO).

FIG. 12 is a graph showing a change in thermal diffusivity of a sample sintered after adding an Al₂O₃ composition to magnesia (MgO).

FIG. 13 is a graph showing changes in thermal diffusivity and density of samples sintered after adding 0.3 wt. % of TiO₂+0.3 wt. % of Nb₂O₅+a trace amount of Al₂O₃ composition to magnesia (MgO).

FIG. 14 is a picture of microstructures of fracture surfaces of a sample in which a 2.0 wt% of TiO₂ composition is added to magnesia (MgO) and a sample in which 2.0 wt% of ZrO₂ composition is added to magnesia (MgO), which are electron-microscopically observed after sintering at 1400° C. for 2 hours, respectively.

### BEST MODE

The above-mentioned objects, features, and advantages of the present disclosure are described in detail with reference to accompanying drawings. Therefore, a person having ordinary knowledge in the art to which the present disclosure pertains may easily implement the technical idea of the present disclosure. In the description of the present disclosure, a detailed description of a well-known technology relating to the present disclosure may be omitted if it unnecessarily obscures the gist of the present disclosure. Preferred embodiments of the present disclosure are described in detail with reference to the accompanying drawings. In the drawings, same reference numerals are used to refer to same or similar components.

Hereinafter, magnesia, a method for producing the magnesia, a highly thermally conductive magnesia composition, and magnesia ceramics using the same according to some embodiments of the present disclosure are described.

According to the present disclosure, the method for producing the magnesia includes adding a donor and an organic solvent to a MgO powder to prepare a mixture, drying the mixture, forming a donor-added MgO granule from the mixture, and thermally treating the donor-added MgO granule.

In addition, a surface oxide layer is formed on the surface of the MgO granule by thermally treating the donor-added MgO granule and has a different composition from that of an inside of the MgO granule.

In the present disclosure, the donor refers to a metal oxide having a higher metal valence than that of MgO and an oxide having a trivalent valence or higher.

Meanwhile, in the method for producing the magnesia of the present disclosure, Mg(OH)₂ may be used instead of the MgO powder. When the Mg(OH)₂ is used, linear shrinkage of a sintered body and the granule after the thermal treatment is 20 to 40%, which is significantly different from 10 to 30% of linear shrinkage in the case of using the MgO.

When producing the magnesia using a Mg(OH)₂ powder as a starting material instead of the MgO powder, it is preferable to add distilled water instead of an organic solvent. Magnesia may be produced under the same conditions as the conditions of a method for producing magnesia using the MgO powder described below, except that the starting material Mg(OH)₂ and the distilled water are used.

The following producing method is described as a method for producing magnesia using the MgO powder.

In the step of adding a donor and an organic solvent to the MgO powder to prepare a mixture, the MgO powder is mixed in a solution prepared by dissolving and dispersing the donor in the organic solvent to prepare a mixture.

A small amount of 0.01 to 10.0 wt. % of a donor including at least one of TiO₂, Nb₂O₅, ZrO₂, Ga₂O₃, Mn₂O₃, B₂O₃, Fe₂O₃, SnO₂, MnO₂, SiO₂, V₂O₅, Ta₂O₅, Sb₂O₅, Y₂O₃, Eu₂O₃, Er₂O₃, or Al₂O₃ is added relative to a total of ₁₀₀ wt. % of the MgO powder and the donor.

When the amount of the donor added is outside of the above range, the magnesia may be difficult to have moisture resistance and thermal conductivity as a ceramic filler for thermal interface material.

After the donor and the organic solvent are added to the MgO powder, a mixture is formed by mixing and pulverizing them by ball milling.

In the step of forming the mixture, the pulverization may be performed for 0.5 to 72 hours.

If the pulverizing time period is less than 0.5 hours, that is, is too short, the mixing and pulverizing effects of the MgO and donor additives may be insufficient. If the pulverizing time period exceeds 72 hours, the pulverizing time period may be too long, thereby making an inefficient process.

2-propanol, anhydrous alcohol, and the like may be used as the organic solvent, and the distilled water may also be used. When the distilled water is used, Mg(OH)₂ is formed. In this case, the sintered body and the granule have linear shrinkage of 20 to 40%, which is significantly different from linear shrinkage of 10 to 30% of the sintered body and the granule after the thermal treatment when 2-propanol or the anhydrous alcohol is used.

Drying the mixture is performed to remove the organic solvent. The organic solvent may be removed by natural drying at 25±5° C. or drying at 25° C. or higher.

In the step of forming the donor-added MgO granules from the mixture, the MgO granule may be formed from the MgO powder using various methods.

For example, MgO granules of various sizes may be formed from the MgO powder and a donor-added MgO granule may be formed by rotating at a rotation speed of 10 to 500 rpm using a cylindrical container. In this case, based on comparison between the powder and the granule, a particle size of the granule is larger than that of the powder.

The donor-added MgO granule may also be produced in the same manner as the method for forming the MgO granule and may be produced by dispersing the donor on the surface of the MgO granule.

The thermal treatment of the donor-added MgO granule may be performed at 800 to 1800° C.

During the thermal treatment, a portion of the donor is moved to the surface of the granule to form a surface oxide layer including MgO and the donor. Accordingly, the surface oxide layer including the MgO-donor is formed on the surface of the MgO granule during the thermal treatment.

The thermal treatment is preferably performed in a temperature range from 800 to 1800° C., and if the thermal treatment temperature is outside of the above range, an oxide layer may not be properly formed on the surface of the MgO granule as a surface protective layer.

Similar to the above-described producing method, producing magnesia using the Mg(OH)₂ powder as the starting material may include adding a donor and distilled water to the Mg(OH)₂ powder to form a mixture, drying the mixture, forming a donor-added Mg(OH)₂ granule from the mixture, and thermally treating the donor-added Mg(OH)₂ powder. Matters of the donor and the thermal treatment are as described above.

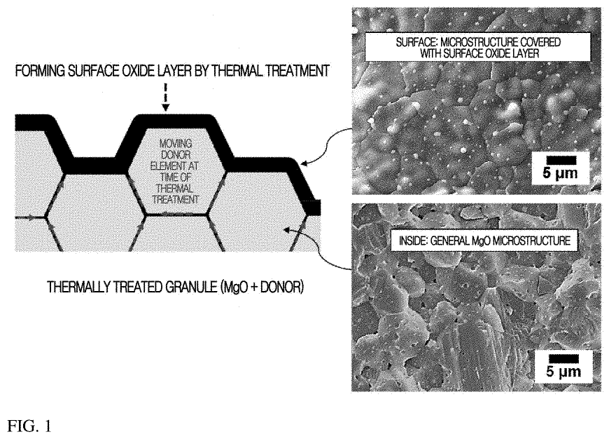

FIG. 1 is a conceptual diagram showing formation of a dense surface oxide layer by thermal treatment, and a picture of a microstructure of a surface oxide layer and an inside of a sintered body during production of the MgO granule of the present disclosure.

As shown in FIG. 1, some donors move along a grain boundary and are collected on a surface of the granule in the thermal treatment process. Accordingly, a surface oxide layer having a dense microstructure that is different from that of an inside of the MgO granule is formed and a surface oxide layer having a composition that is different from that of an inside of the MgO granule is formed on the surface of the granule.

In the present disclosure, low moisture resistance of the MgO may be improved by forming the surface oxide layer.

As described above, in the present disclosure, a surface oxide layer including the MgO and the donor are formed as a protective layer on the surface of the MgO granule using a method for producing magnesia by forming a donor-added MgO granule or a donor-added Mg(OH)₂ granule using a MgO powder raw material or Mg(OH)₂ powder raw material and then thermally treating, thereby obtaining moisture resistance and excellent thermal properties.

For example, the surface oxide layer including metal oxides such as Mg₂TiO₄ and Zr_{0.904}Mg_{0.096}O_{1.904} including Mg and at least one of metal elements other than the Mg is free from the moisture absoption problem, thereby improving the moisture resistance of MgO.

Magnesia prepared from the MgO powder raw material or the Mg(OH)₂ powder raw material of the present disclosure includes a MgO granule and a surface oxide layer formed on the surface of the MgO granule. In this case, for the magnesia, the surface oxide layer has a different composition from that of the inside of the MgO granule and includes MgO and the donor.

The surface oxide layer has a dense microstructure compared to the microstructure of the inside of the MgO granule.

The donor is a metal oxide having a higher metal valence than that of the MgO and includes at least one of TiO₂, Nb₂O₅, ZrO₂, Ga₂O₃, Mn₂O₃, B₂o₃, Fe₂O₃, SnO₂, MnO₂, SiO₂, V₂O₅, Ta₂O₅, Sb₂O₅, Y₂O₃, Eu₂O₃, Er₂O₃, or Al₂O₃.

The donor (the metal oxide) material may be included in an amount of 0.01 to 10.0 wt. %, preferably 0.01 to 2.0 wt. %, relative to a total of 100 wt. % of the magnesia.

Specifically, the magnesia (MgO) includes TiO₂ and Nb₂O₅ and satisfies the following Equation (6).

MgO+x wt. % of TiO₂+y wt. % of Nb₂O₅≤100 wt. % Equation (6)

In Equation (6), x and y are 0<x,y≤2.0 and the remainder is MgO.

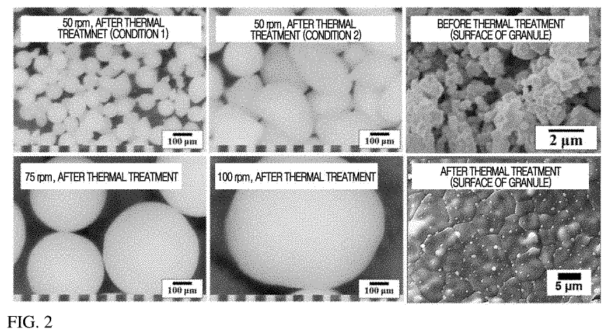

FIG. 2 is a microstructure picture showing shapes and sizes of MgO granules produced according to a producing method of the present disclosure, and a microstructure picture of surfaces thereof before and after thermal treatment (at 1400° C. for 2 h).

Referring to FIG. 2, MgO granules having various sizes and shapes may be produced under producing conditions (rpm). Compared to the MgO granule before the thermal treatment, a surface oxide layer formed on the surface of the MgO granule after the thermal treatment shows a dense microstructure.

The surface oxide layer has a dense microstructure compared to the microstructure of the inside of the MgO granule.

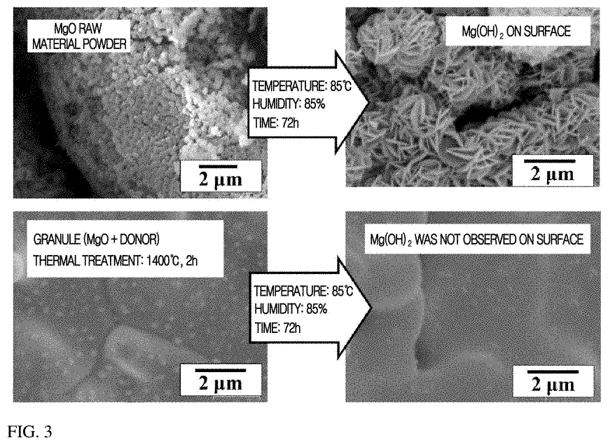

FIG. 3 is a picture showing a difference between water resistance to a MgO raw material powder and water resistance to a MgO granule formed by adding a donor to a MgO powder and thermally treating (at 1400° C. for 2h).

The MgO raw material powder is a powder to which a donor is not added, and Mg(OH)₂ was observed on a surface of the powder when the MgO raw material powder is maintained for 72 hours in an environment at a temperature of 85° C. and humidity of 85%.

In contrast, when the granule is prepared from the donor-added MgO powder according to the producing method of the present disclosure and by thermally treating at 1400° C. and is maintained for 72 hours in an environment of a temperature of 85° C. and humidity of 85%, Me(OH)₂ was not observed on a surface of the granule.

According to the present disclosure, these results show that the MgO granule formed by adding the donor to the MgO powder raw material and that is subjected to thermal treatment did not react with water, thereby improving moisture resistance.

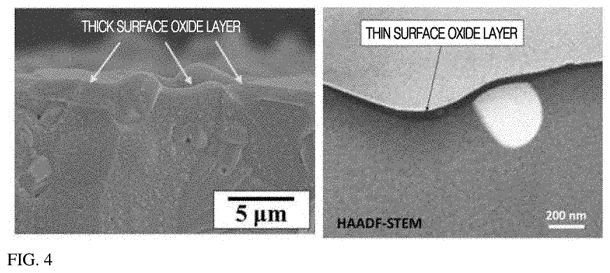

FIG. 4 is a picture of a microstructure of fracture surfaces of a sample of MgO+0.3 wt. % of TiO₂+0.3 wt. % of Nb₂O₅+0.2 wt. % of SiO₂ (at a left side) and a sample of MgO+0.3 wt. % of TiO₂+0.3 wt. % of Nb₂O₅ (at a right side), which are thermally treated at 1400° C. for 2h, to identify thicknesses of surface oxide layers thereof.

A surface oxide layer is formed by thermally treating the donor-added MgO and is different from an inside of a sample (a granule). It may be seen that a surface oxide layer including MgO-donor and having a thickness of 0.1 to 3 μm was formed in the sample of MgO+0.3 wt. % of TiO₂+0.3 wt. % of Nb₂O₅+0.2 wt. % of SiO₂. A surface oxide layer thinner than 0.1 μm was also observed in a TEM image of the sample of MgO+0.3 wt. % of TiO₂+0.3 wt. % of Nb₂O₅.

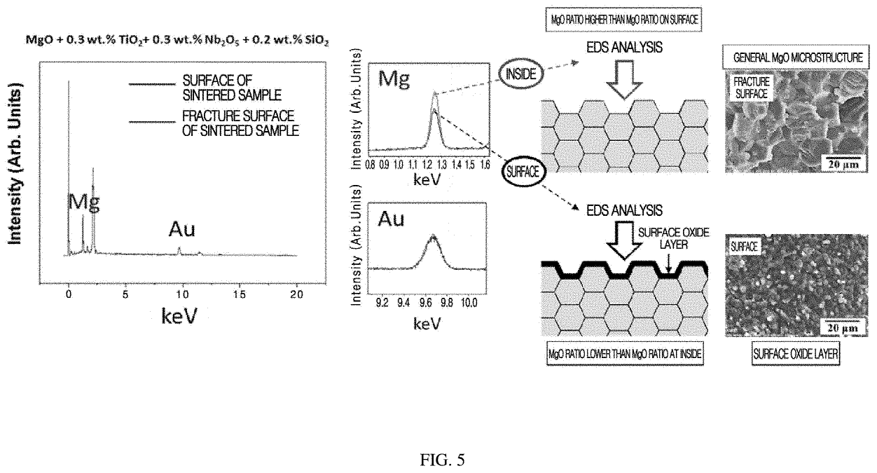

FIG. 5 is an energy dispersive X-ray spectroscopy (EDS) analysis results and a microstructure picture used to identify formation of a surface oxide layer including a MgO-donor in a sample of MgO+0.3 wt. % of TiO₂+0.3 wt. % of Nb₂O₅+0.2 wt. % of SiO₂ thermally treated at 1400° C. for 2h.

A surface oxide layer having a different phase from that of an inside thereof was formed by thermally treating the donor-added MgO.

It was found that a MgO content at an inside of the sample was higher than a MgO content on a surface of the sintered sample, which simplifies that a surface oxide layer including an MgO-donor is formed on the surface of the sintered body.

In addition, the content of the donor inside the surface oxide layer was higher than the content of the donor inside the MgO granule, which simplifies that the donor was added in an amount of 2.0 wt. % or less relative to 100 wt. % of magnesia, and a concentration of the donor in the surface oxide layer was higher than an average concentration of the donor of a whole (the granule and the surface oxide) and the content of the donor in the surface oxide layer is higher than that of the donor in the granule. The content of the donor in the surface oxide layer was measured at a concentration of at least twice or more, preferably three times or more, more preferably 10 times or more than the content of the donor at the inside of the granule.

According to the present disclosure, the highly thermally conductive magnesia (MgO) composition includes TiO₂, Nb₂O₅, ZrO₂, or Al₂O₃ in a MgO matrix and satisfies the following Equation (1), Equation (2), Equation (3), or Equation (4).

MgO+x wt. % of TiO₂≤100 wt. % Equation (1)

MgO+y wt. % of Nb₂O₅≤100 wt. % (2)

MgO+z wt. % of ZrO₂≤100 wt. % (3)

MgO+w wt. % of Al₂O₃≤100 wt. % Equation (4)

In Equations (1) to (4), x, y, z, and w are 0<x, y, z, w<10.0 and the remainder is MgO.

Preferably, x may satisfy a range of 0<x<10.0 in Equation (1), y may satisfy a range of 0<y<5.0 in Equation (2), z may satisfy a range of 0<z<4.0 in Equation (3), and w may satisfy a range of 0<w<0.8 in Equation (4). More preferably, y may satisfy a range of 0<y<1.0 in Equation (2).

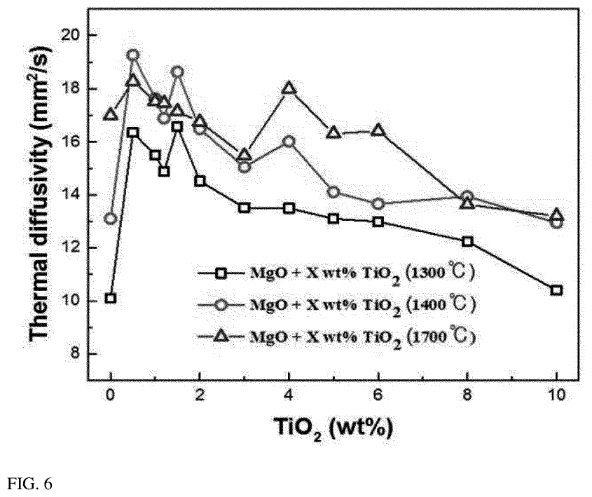

Referring to FIG. 6 and Table 1, it may be seen that, when titanium dioxide (TiO₂) is added to the magnesia (MgO) as a donor in an amount of exceeding 0 wt. % and equal to or less than 10.0 wt. %, thermal diffusivity of magnesia (MgO) ceramics according to the present disclosure is increased.

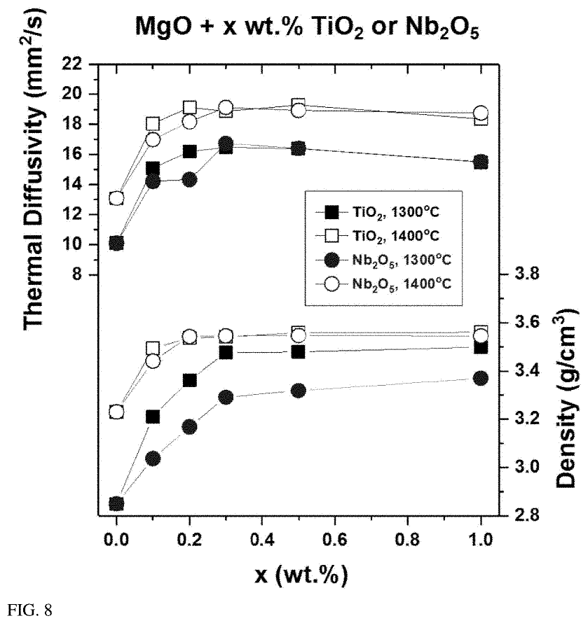

In particular, referring to FIGS. 6, 8 and Table 1, it may be seen that, when the titanium dioxide (TiO₂) is added to the magnesia (MgO) as the donor in an amount of exceeding 0 wt. % and equal to or less than 2.0 wt. % and the magnesia (MgO) ceramics are sintered at 1400° C., thermal diffusivity thereof is similar or superior to that of magnesia (MgO) ceramics sintered at 1700° C.

In addition, referring to FIGS. 6, 8, and Table 1, it may be seen that, when the titanium dioxide (TiO₂) is added to the magnesia (MgO) as a donor in an amount of exceeding 0 wt. % and equal to or less than 10.0 wt. % and is sintered at 1300° C. to 1400° C., the TiO₂ donor-added magnesia (MgO) has a high relative density of 96% or more in all compositions, which is significantly improved over a relative density of 80 to 90% of the magnesia (MgO) ceramics sintered at a same sintering temperature.

In addition, it may be seen that thermal diffusivity of the composition sintered at a low temperature of 1300 to 1400° C. after adding titanium dioxide (TiO₂) in an amount of exceeding 0 wt. % and equal to or less than 10.0 wt. % to the magnesia (MgO) is higher than that of the magnesia (MgO) sintered at a same sintering temperature.

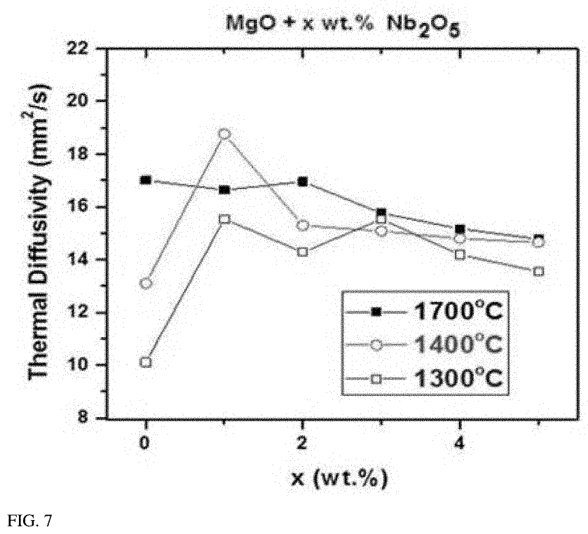

Referring to FIGS. 7 and 8, when niobium pentoxide (Nb₂O₅) is added to magnesia (MgO) as a donor in an amount of exceeding 0 wt. % and equal to or less than 5.0 wt. %, magnesia (MgO) ceramics according to the present disclosure sintered at 1300 to 1400° C. has thermal diffusivity that is similar or superior to that of magnesia (MgO) ceramics sintered at 1700° C.

In particular, referring to FIGS. 7 and 8, it may be seen that, when 1.0 wt. % or less of niobium pentoxide (Nb₂O₅) is added to the magnesia (MgO) as a donor, the sample sintered at 1400° C. has superior thermal diffusivity than that of the magnesia (MgO) ceramics sintered at 1700° C.

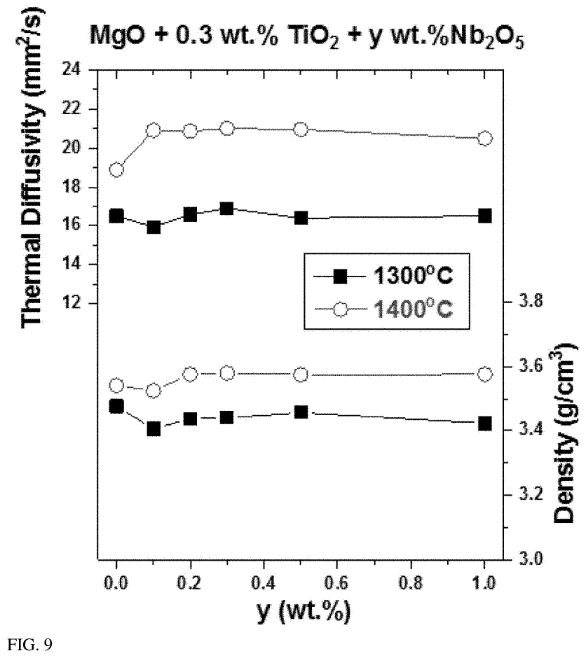

In FIG. 9, it may be seen that, when 0.3 wt. % of TiO₂ is fixed and Nb₂O₅ is further added in an amount of 1.0 wt. % or less, an improvement in thermal conductivity of magnesia (MgO) ceramics is observed.

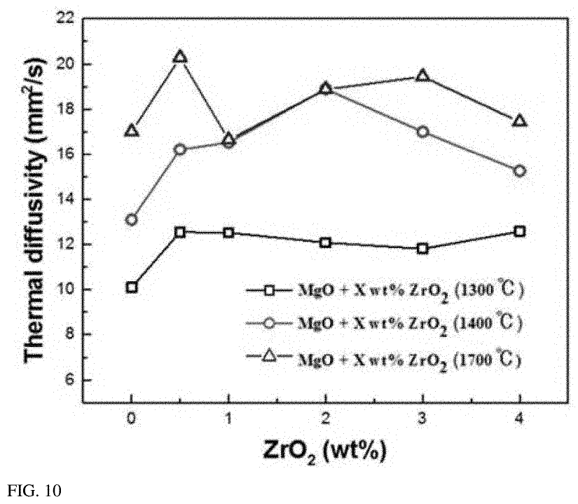

Referring to FIG. 10, it may be seen that, when zirconium oxide (ZrO₂) is added to the magnesia (MgO) as a donor in an amount of exceeding 0 wt. % and equal to or less than 4.0 wt. %, the magnesia (MgO) ceramics according to the present disclosure sintered at 1400° C. has similar thermal diffusivity to that of magnesia (MgO) ceramics sintered at 1700° C.

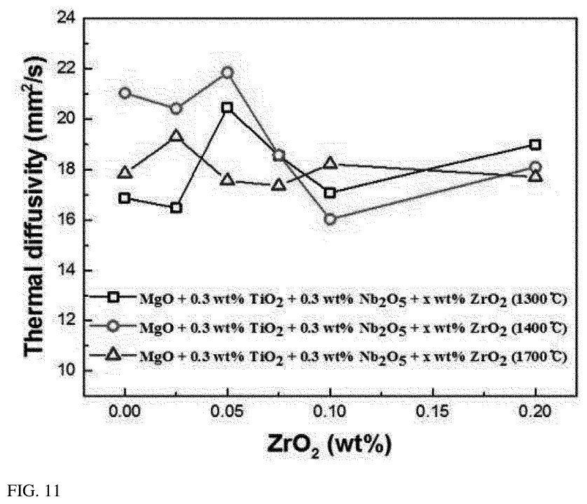

Referring to FIG. 11, it may be seen that, even when titanium dioxide (TiO₂), the niobium pentoxide (Nb₂O₅), and the zirconium oxide (ZrO₂) are added together to the magnesia (MgO) as donors, thermal diffusivity of a sample sintered at 1300 to 1400° C. is similar or superior to thermal diffusivity of magnesia (MgO) ceramics sintered at 1700° C.

In particular, referring to FIG. 11, 0.3 wt. % of titanium dioxide (TiO₂), 0.3 wt. % of niobium pentoxide (Nb₂O₅), and the zirconium oxide (ZrO₂) in an amount of exceeding 0 wt. % and equal to or less than 0.05 wt. % are added to the magnesia (MgO) as donors, it may be seen that thermal diffusivity of magnesia (MgO) ceramics according to the present disclosure is significantly higher than that of the magnesia (MgO) ceramics sintered at 1700° C.

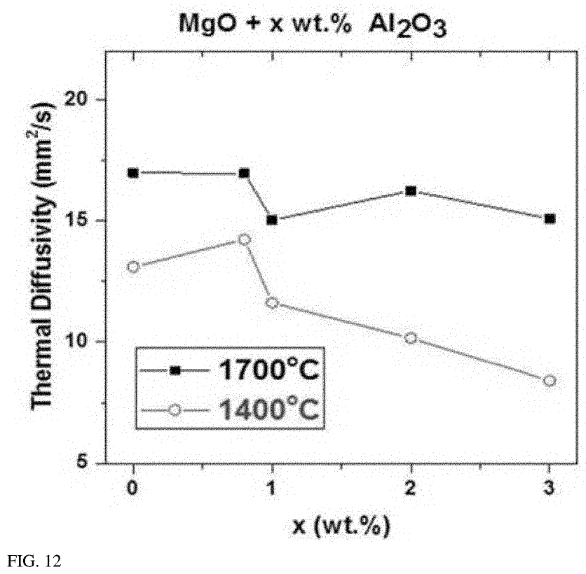

Referring to FIG. 12, it may be seen that thermal diffusivity of magnesia (MgO) ceramics according to the present disclosure is increased when alumina (Al₂O₃) is added to the magnesia (MgO) as a donor in an amount of exceeding 0 wt. % and equal to or less than 0.8 wt. %.

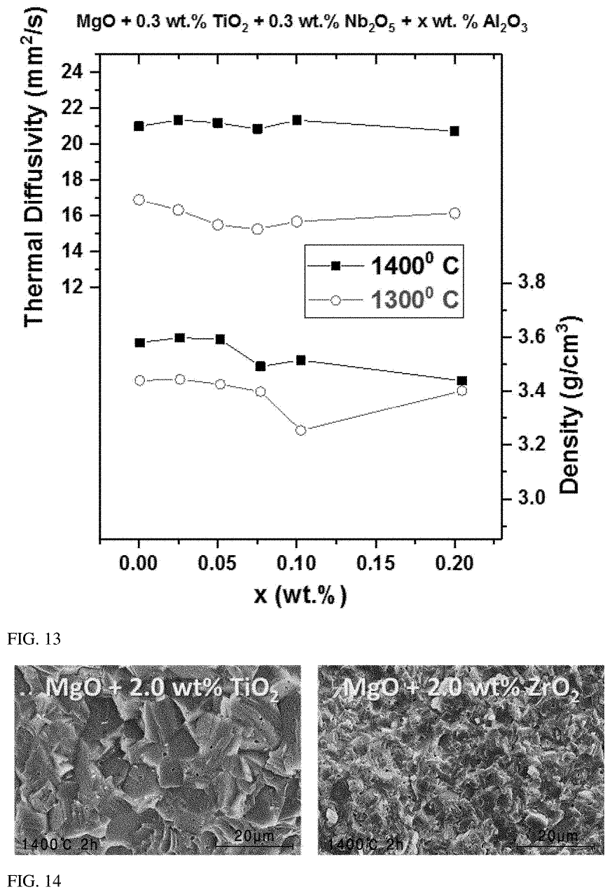

In FIG. 13, when 0.3 wt. % of TiO₂ and 0.3 wt. % of Nb₂O₅ were fixed and Al₂O₃ was further added, the thermal conductivity property thereof was not significantly deteriorated and a similar thermal conductivity tendency was observed.

The highly thermally conductive magnesia (MgO) composition according to the present disclosure includes TiO₂, Nb₂O₅, and ZrO₂ in the MgO matrix and satisfies the following Equation (5).

MgO+0.3 wt. % of TiO₂+0.3 wt. % of Nb₂O₅+z wt. % ZrO₂≤100 wt. %

In Equation (5), z is 0<z≤0.05 and the remainder is MgO.

As described above, referring to FIGS. 6 to 13 and Table 1, the sample in which a small amount of at least one metal oxide composition of trivalent or higher valent TiO₂, Nb₂O₅, ZrO₂, Ga₂O₃, Mn₂O₃, B₂O₃, Fe₂O₃, SnO₂, MnO₂, SiO₂, V₂O₅, Ta₂O₅, Sb₂O₅, Y₂O₃, Eu₂O₃, Er₂O₃, or Al₂O₃, which may act as donors, was added to MgO had an improved thermal property over a sample in which a donor was not added to the MgO.

According to the present disclosure, the method for producing magnesia ceramics includes adding a donor to magnesia (MgO) and mixing the donor and the magnesia (MgO), producing at least one of highly thermally conductive magnesia (MgO) composition, drying the composition, and sintering the composition. The sintering may be performed at 1200 to 1500° C.

Sinterability thereof may be improved by adding at least one material that may act as a donor, thereby achieving low-temperature sintering of the magnesia (MgO).

The donor includes at least one of TiO₂, Nb₂O₅, ZrO₂, Ga₂O₃, Mn₂O₃, Fe₂O₃, SnO₂, MnO₂, SiO₂, V₂O₅, Ta₂O₄, Sb₂O₅, Y₂O₃, Eu₂O₃, Er₂O₃, or Al₂O₃.

Magnesia (MgO) ceramics of the present disclosure is formed by adding an appropriate amount of titanium dioxide (TiO₂), niobium pentoxide (Nb₂O₅), zirconium oxide (ZrO₂) and/or alumina (Al₂O₃) to magnesia (MgO) as donors and mixing them in 2-propanol as a solvent in a ball mill, and subsequently pulverizing and drying them. The mixed powder is molded at a pressure of 100 MPa in a circular metal mold having a diameter of 15 mm and is sintered for two hours at a temperature of 1200° C. to 1500° C. using an electric furnace or a gas furnace to prepare magnesia ceramics.

Highly thermally conductive magnesia (MgO) ceramics produced by the producing method of the present disclosure may have a relative density value of 93% to 100% compared to theoretical density (3.58 g/cm³) of magnesia (MgO). Alternatively, when a donor element heavier than Mg is added, highly thermally conductive magnesia (MgO) ceramics may have a density higher than 3.58 g/cm³. The highly thermally conductive magnesia (MgO) ceramics may have a thermal diffusivity value of 10.4 mm²/s to 21.9 mm²/s.

FIG. 14 is a picture of microstructures of fracture surfaces electron-microscopically observed after sintering a sample in which a 2.0 wt. % of TiO₂ composition is added to magnesia (MgO) and a sample in which 2.0 wt. % of ZrO₂ composition is added to magnesia (MgO) at 1400° C. for 2 h.

Referring to FIG. 14, when the samples were sintered at 1400° C., the samples have a dense microstructure.

As described above, specific embodiments of magnesia, a producing method thereof, a highly thermally conductive magnesia composition, and magnesia ceramics using the same are as follows.

1. Density

Density was measured by Archimedes method using xylene.

2. Thermal Diffusivity

Thermal diffusivity was measured using a laser flash method. (LFA 457, MicroFlash, Netzsch Instruments Inc., Germany)

[Table 1] shows density and thermal diffusivity properties of samples produced by sintering magnesia (MgO) compositions in a temperature range provided by the present disclosure.

TABLE 1

| | | | | | | | | | | | | Sintering | | Thermal |
|---|---|---|---|---|---|---|---|---|---|---|---|---|---|---|
| | Addition Amount (wt. %) | | | | | | | | | | | Temper- | | Diffu- |
| | Additive | | | | | | | | | | | ature | Density | sivity |
| Classification | TiO₂ | Nb₂O₂ | ZrO₂ | Al₂O₃ | V₂O₅ | B₂O₃ | Y₂O₃ | SiO₂ | Eu₂O₃ | Er₂O₃ | Fe₂O₃ | (° C.) | (g/cm³) | (mm²/s) |
| Embodiment 1 | 0.5 | | | | | | | | | | | 1300 | 3.48 | 16.4 |
| Embodiment 2 | 0.5 | | | | | | | | | | | 1300 | 3.52 | 16.6 |
| Embodiment 3 | 10.0 | | | | | | | | | | | 1300 | 3.53 | 10.4 |
| Embodiment 4 | | | 0.5 | | | | | | | | | 1300 | 3.02 | 12.6 |
| Embodiment 5 | | | 4.0 | | | | | | | | | 1300 | 3.11 | 12.6 |
| Embodiment 6 | | 1.0 | | | | | | | | | | 1300 | 3.37 | 15.5 |
| Embodiment 7 | | 3.0 | | | | | | | | | | 1300 | 3.42 | 15.5 |
| Embodiment 8 | 0.3 | 0.3 | | | | | | | | | | 1300 | 3.44 | 16.9 |
| Embodiment 9 | 0.3 | 0.3 | 0.05 | | | | | | | | | 1300 | 3.54 | 20.5 |
| Embodiment 10 | 0.3 | 0.3 | | | | | | | | | | 1300 | 3.51 | 17.4 |
| Embodiment 11 | 0.3 | 0.3 | | | | 0.2 | | | | | | 1300 | 3.54 | 18.0 |
| Embodiment 12 | 0.3 | 0.3 | | | | | 0.2 | | | | | 1300 | 3.38 | 15.6 |
| Embodiment 13 | 0.3 | 0.3 | | | | | | 0.2 | | | | 1300 | 3.50 | 18.1 |
| Embodiment 14 | 0.3 | 0.3 | | | | | | | 0.1 | | | 1350 | 3.55 | 18.4 |
| Embodiment 15 | 0.3 | 0.3 | | | | | | | | 0.1 | | 1350 | 3.54 | 18.2 |
| Embodiment 16 | 0.5 | | | | | | | | | | | 1400 | 3.56 | 19.3 |
| Embodiment 17 | 1.5 | | | | | | | | | | | 1400 | 3.57 | 18.6 |
| Embodiment 18 | 10.0 | | | | | | | | | | | 1400 | 3.59 | 12.9 |
| Embodiment 19 | | | 2.0 | | | | | | | | | 1400 | 3.51 | 18.9 |
| Embodiment 20 | | | 3.0 | | | | | | | | | 1400 | 3.52 | 17.0 |
| Embodiment 21 | | 1.0 | | | | | | | | | | 1400 | 3.55 | 18.8 |
| Embodiment 22 | | 2.0 | | | | | | | | | | 1400 | 3.57 | 15.3 |
| Embodiment 23 | | | | 0.8 | | | | | | | | 1400 | 3.44 | 14.2 |
| Embodiment 24 | 0.3 | 0.3 | | | | | | | | | | 1400 | 3.58 | 21.0 |
| Embodiment 25 | 0.3 | 0.3 | 0.05 | | | | | | | | | 1400 | 3.59 | 21.9 |
| Embodiment 26 | 0.3 | 0.3 | | | 0.2 | | | | | | | 1400 | 3.51 | 16.3 |
| Embodiment 27 | 0.3 | 0.3 | | | | 0.2 | | | | | | 1400 | 3.58 | 16.3 |
| Embodiment 28 | 0.3 | 0.3 | | | | | 0.2 | | | | | 1400 | 3.53 | 18.9 |
| Embodiment 29 | 0.3 | 0.3 | | | | | | 0.2 | | | | 1400 | 3.56 | 21.1 |
| Embodiment 30 | 0.3 | 0.3 | | | | | | | 0.1 | | | 1400 | 3.56 | 19.5 |
| Embodiment 31 | 0.3 | 0.3 | | | | | | | | 0.1 | | 1400 | 3.57 | 18.6 |
| Embodiment 32 | 0.1 | 0.2 | 0.6 | | | | 0.03 | 0.1 | | | 0.01 | 1400 | 3.56 | 17.5 |
| Comparative | | | | | | | | | | | | 1300 | 2.85 | 10.1 |
| Example 1 | | | | | | | | | | | | | | |
| Comparative | | | | | | | | | | | | 1400 | 3.23 | 13.1 |
| Example 2 | | | | | | | | | | | | | | |
| Comparative | | | | | | | | | | | | 1700 | 3.53 | 17.0 |
| Example 3 | | | | | | | | | | | | | | |

Embodiment 1: 0.5 wt. % of titanium dioxide (TiO₂) was added to magnesia (MgO) as a donor, was mixed with magnesia (MgO) in 2-propanol as a solvent in a ball mill, and then they were pulverized and dried.

After molding the dried mixed powder at a pressure of 100 MPa in a circular metal mold having a diameter of 15 mm, the mixed powder was sintered for 2 hours at a temperature of 1300° C. using an electric furnace.

Embodiments 2 to 32: Highly thermally conductive magnesia ceramics were prepared in the same manner as in Embodiment 1, except that titanium dioxide (TiO₂), niobium pentoxide (Nb₂O₅), zirconium oxide (ZrO₂), alumina (Al₂O₃), V₂O₅, B₂O₃, Y₂O₃, SiO₂, Eu₂O₃, Er₂O₃, and Fe₂O₃ were added to the magnesia (MgO) of Embodiment 1 as donors, in addition amounts shown in Table 1 and they were sintered at a temperature of 1300° C. or 1400° C.

Comparative Example 1: Magnesia ceramics were produced in the same manner as in Embodiment 1, except that a donor was not added to the magnesia (MgO) of Embodiment 1.

Comparative Example 2: Magnesia ceramics were produced in the same manner as in Embodiment 1, except that a donor was not added to the magnesia (MgO) of Embodiment 1 and the magnesia (MgO) was sintered at a temperature of 1400° C.

Comparative Example 3: Magnesia ceramics were produced in the same manner as in Embodiment 1, except that a donor was not added to the magnesia (MgO) of Embodiment 1 and the magnesia (MgO) was sintered at a temperature of 1700° C.

Referring to Table 1, it may be seen that the sintering of the magnesia (MgO) composition is sufficiently performed in the temperature range of 1300° C. to 1400° C. and the density and the thermal diffusivity of the magnesia (MgO) ceramics change according to the composition ratio of the donor.

Specifically, referring to Embodiments 1 to 32, when at least one of titanium dioxide (TiO₂), niobium pentoxide (Nb₂O₅), zirconium oxide (ZrO₂) alumina (Al₂O₃), V₂O₅, B₂O₃, Y₂O)₃, SiO₂, Eu₂O₃, Er₂O₃, or Fe₂O₃ was added to magnesia (MgO) in a sintering temperature range from 1300° C. to 1400° C., it may be seen that the magnesia (MgO) ceramics according to the present disclosure has an excellent sintering density value of 3.02 g/cm³ to 3.59 g/cm³ and an excellent thermal diffusivity value of 10.4 mm²/s to 21.9 mm²/s.

As described above, it may be seen that the highly thermally conductive magnesia (MgO) ceramics produced by the producing method according to the present disclosure has a higher sintering density value than that of the magnesia (MgO) ceramics in the related art. In this case, the highly thermally conductive magnesia (MgO) ceramics produced using the producing method according to the present disclosure has a higher thermal diffusivity value that that of the magnesia (MgO) ceramics in the related art and may be applied to a heat dissipating ceramic material.

The present disclosure has been described as described above with reference to exemplary drawings; however, the present disclosure is not limited to the embodiments and the drawings disclosed herein, and various modifications can be made by those skilled in the art within the scope of the technical idea of the present disclosure. Further, even if working effects obtained based on configurations of the present disclosure are not explicitly described in the description of embodiments of the present disclosure, effects predictable based on the corresponding configuration have to be recognized.

1.-7. (canceled)

8. Magnesia (MgO), comprising:
a MgO granule; and
a surface oxide layer formed on a surface of the MgO granule,
wherein a composition of the surface oxide layer is different from a composition of an inside of the MgO granule.

9. The magnesia (MgO) of claim 8, wherein a donor at an inside of the surface oxide layer comprises at least one of TiO₂, Nb₂O₅, ZrO₂, Ga₂O₃, Mn₂O₃, B₂O₃, Fe₂O₃, SnO₂, MnO₂, SiO₂, V₂O₅, Ta₂O₅, Sb₂O₅, Y₂O₃, Eu₂O₃, or Al₂O₃.

10. (canceled)

11. The magnesia (MgO) of claim 8,
wherein the magnesia comprises TiO₂ and Nb₂O₅ and satisfies the following Equation (6):
MgO+x wt. % of TiO₂+y wt. % of Nb₂O₅≤100 wt. % Equation (6)
(In Equation (6), x and y are 0<x,y≤2.0 and the remainder is MgO.

12. A magnesia (MgO) comprising:
a MgO granule: and
a surface oxide layer formed on a surface of the MgO granule.
wherein density of the surface oxide layer is higher than density of an inside of the MgO granule.

13. The magnesia (MgO) of claim 17, wherein a donor at an inside of the surface oxide layer comprises at least one of TiO₂, Nb₂O₅, ZrO₂, Ga₂O₃, Mn₂O₃, B₂O₃, Fe₂O₃, SnO₂, MnO₂, SiO₂, V₂O₅, Ta₂O₅, Sb₂O₅, Y₂O₃, Eu₂O₃, Er₂O₃, or Al₂O₃.

14. Magnesia (MgO), comprising:
wherein
a MgO granule; and
a surface oxide layer formed on a surface of the MgO granule.
an inside of the surface oxide layer is higher than a content of a donor at an inside of the granule.

15. (canceled)

16. The magnesia (MgO) of claim 1,
wherein the donor at the inside of the surface oxide layer comprises at least one of TiO₂, Nb₂O₅, ZrO₂, Ga₂O₃, Mn₂O₃, B₂O₃, Fe₂O₃, SnO₂, MnO₂, SiO₂, V₂O₅, Ta₂O₅, Sb₂O₅, Y₂O₃, Eu₂O₃, Er₂O₃, or Al₂O₃.
